(19) United States
(12) Patent Application Publication
(10) Pub. No.: US 2011/0071826 A1
(43) Pub. Date: Mar. 24, 2011

(54) METHOD AND APPARATUS FOR ORDERING RESULTS OF A QUERY

(75) Inventors: Changxue Ma, Barrington, IL (US); Harry M. Bliss, Evanston, IL (US)

(73) Assignee: MOTOROLA, INC., Schaumburg, IL (US)

(21) Appl. No.: 12/564,968

(22) Filed: Sep. 23, 2009

(51) Int. Cl. G10L 15/26; G06F 17/30

(52) U.S. Cl. 704/235; 704/E15.004; 704/E15.014; 707/E17.014

(57) ABSTRACT

A method and apparatus for ordering results from a query is provided herein. During operation, a spoken query is received and converted to a textual representation, such as a word lattice. Search strings are then created from the word lattice. For example a set search strings may be created from the N-grams, such as unigrams and bigrams, of the word lattice. The search strings may be ordered and truncated based on confidence values assigned to the n-grams by the speech recognition system. The set of search strings are sent to at least one search engine, and search results are obtained. The search results are then re-arranged or reordered based on a semantic similarity between the search results and the word lattice.

### FIELD OF THE INVENTION

The present invention relates generally to generating a query and in particular, to a method and apparatus for ordering results of a query.

### BACKGROUND OF THE INVENTION

Generating search queries is an important activity in daily life for many individuals. For example, many jobs require individuals to mine data from various sources. Additionally, many individuals will provide queries to search engines in order to gain more information on a topic of interest. For convenience, users of these devices are turning to speech-based systems for generating queries. Typically a speech-to-text engine converts the spoken query to text. The resulting textual query is then processed by a standard text-based search engine. There are multiple problems associated with such speech-to-text generated queries. Specifically, the speech-to-text conversion may be ambiguous, leading to spurious and poor-ranked search results. Studies have shown that few people look beyond the first 20 or 30 search results. There is therefore a need to increase the performance of such systems, and specifically for ordering search results generated from a speech-to-text query to reduce spurious and poor-ranked search results.

### BRIEF DESCRIPTION OF THE DRAWINGS

FIG. 1. is a block diagram of a system for generating a query from speech and ordering the query results.

FIG. 2 illustrates a word lattice.

FIG. 3. is a flow chart showing operation of the system of FIG. 1.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. Those skilled in the art will further recognize that references to specific implementation embodiments such as “circuitry” may equally be accomplished via replacement with software instruction executions either on general purpose computing apparatus (e.g., CPU) or specialized processing apparatus (e.g., DSP). It will also be understood that the terms and expressions used herein have the ordinary technical meaning as is accorded to such terms and expressions by persons skilled in the technical field as set forth above except where different specific meanings have otherwise been set forth herein.

### DETAILED DESCRIPTION OF THE DRAWINGS

In order to address the above-mentioned need, a method and apparatus for ordering results from a query is provided herein. During operation, a spoken query is received and converted to a textual representation, such as a word lattice. Search strings are then created from the word lattice. For example a set of search strings may be created from the N-grams, such as unigrams and bigrams, of the word lattice. The search strings may be ordered and truncated based on confidence values assigned to the n-grams by the speech recognition system. The set of search strings are sent to at least one search engine, and search results are obtained. The search results are then re-arranged or reordered based on a semantic similarity between the search results and the word lattice.

When presenting the results of the search, the order of the results presented to a user is determined by confidence levels used in combination with the text of the search results. The ordering of search results takes into account the semantic similarity of each search result with the stored search terms and stored n-grams and confidence levels where the most similar result is first followed by the next most similar result, etc. In a preferred embodiment, semantic similarity is determined by Latent Semantic Analysis. Alternatively, there are numerous semantic matching algorithms which can be used such as semantic tagging, deep parsing, etc.

By reordering search results received from the textual query a more representative result of a spoken search may be presented to the user. Specifically, since the speech-to-text conversion may not be exact, the reordering of the search results helps remove poor search results from the first 20 or 30 search results.

The present invention encompasses a method for reordering search results obtained from a search engine. The method comprises the steps of receiving speech, creating a word lattice from the received speech, creating a query vector comprising search strings from the word lattice, and sending the search strings to a search engine. Search results are received from the search engine and reordered based on a semantic similarity between the search results and the word lattice.

The present invention additionally encompasses a method for reordering search results obtained from a search engine. The method comprises the steps of creating a query vector comprising search strings from a word lattice created from spoken words, sending the search strings to a search engine, and receiving search results from the search engine. The search results are reordered based on a semantic similarity between the search results and the word lattice.

The present invention additionally encompasses an apparatus for reordering search results. The apparatus comprises logic circuitry creating a query vector comprising search strings from a word lattice, the logic circuitry sending the search strings to a search engine, receiving search results from the search engine, and reordering the search results based on a semantic similarity between the search results and the word lattice.

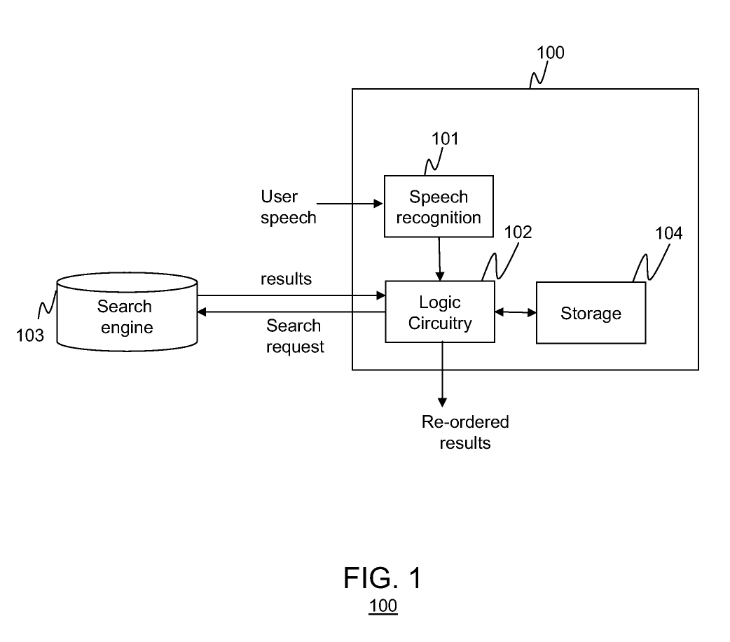

Turning now to the drawings, where like numerals designate like components, FIG. 1 is a block diagram showing apparatus 100 capable of generating a query from spoken content, and reordering search results to more accurately reflect what was spoken. As shown, system 100 comprises speech recognition circuitry 101, logic circuitry 102, and storage 104. Additionally search service 103 is provided, and preferably comprises an internet-based search engine such as, but not limited to Google®, Bing®, Yahoo®, . . . , etc. However, in alternate embodiments of the present invention search service 103 may comprise other search services such as file search services, database search services, . . . , etc. Finally, search service 103 is shown existing external to apparatus 100, however, in alternate embodiments of the present invention search service 103 may be located internal to apparatus 100.

Speech recognition circuitry 101 comprises commonly known circuitry that converts user speech into text. Logic circuitry 102 comprises a digital signal processor (DSP), general purpose microprocessor, a programmable logic device, or application specific integrated circuit (ASIC) and is utilized to formulate a query and reorder query results. Finally, storage/database 104 comprises standard random access memory and is used to store information related to confidence values and n-grams of query terms along with the query terms.

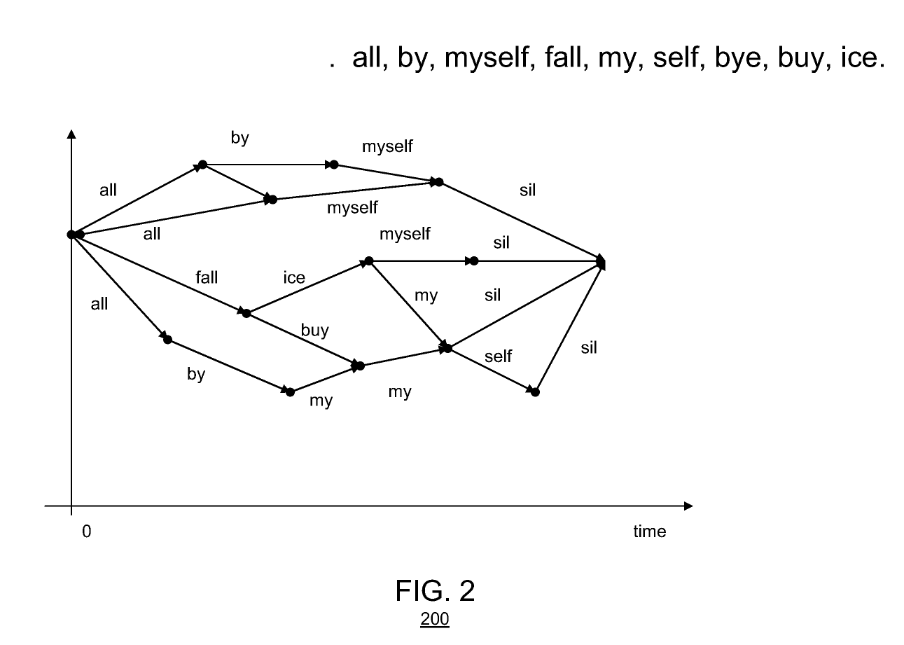

During operation a user's spoken query is received at speech recognition circuitry 101. Speech recognition circuitry 101 outputs text representative of the spoken query as a word lattice. Word lattices are known in the art and comprise a weighted graph of word hypotheses derived from the spoken input. FIG. 2 illustrates a word, or phoneme lattice.

The phoneme lattice 200 includes a plurality of words recognized at a beginning and ending times within an utterance. Each word can be associated with an acoustic score (e.g., a probabilistic score). For example, if a user requests a query for the spoken words “all by myself”, speech recognition may return the word lattice shown in FIG. 2 to logic circuitry 102.

Logic circuitry 102 receives the text output from speech recognition circuitry 101 as word lattice 200, and generates a set of queries (search strings). In particular, the search strings comprises N-grams, unigrams, and bigrams of the word lattice output of the speech-to-text conversion system. For example, for the above example, the set of queries may comprise “all”, “by”, “myself”, “fall”, “my”, “self”, “bye”, “buy”, “ice”, “all by”, “all myself”, “all fall”, “all my”, . . . , “buy ice”, . . . “all by myself”, “all by fall”, “all by my”, . . . , “bye buy ice”.

As is evident, the queries may become quite numerous. Because of this, in an embodiment of the present invention, the queries may be limited to a number of n-grams. This limitation may be accomplished by selecting those with high confidence score and excluding those so-call stop words which appears often in every documents such as ‘of’, ‘in’, etc.

Once textual queries have been generated by logic circuitry 102, logic circuitry 102 sends the queries to search service 103. As discussed above, in one embodiment of the present invention the queries are sent via the internet to a web-based search engine such as Google®. In response query results are received. In this particular example, it is envisioned that a plurality of rank ordered web pages are received for each query. However, as one of ordinary skill in the art would recognize, depending upon what was searched (web pages, files, text, . . . , etc.), the rank-ordered results could comprise rank-ordered files, rank-ordered text, . . . , etc.

As discussed above, there are multiple problems associated with such speech-to-text generated queries. Specifically, the speech-to-text conversion may not be exact, leading to spurious and poor-ranked search results. Studies have shown that few people look beyond the first 20 or 30 search results. In order to address this issue, confidence values, n-grams of query terms, along with the query terms are stored, and are used to re-arrange and refine the combined search results for all queries. By reordering search results received from the search strings a more representative result of a spoken search may be presented to the user. Specifically, since the speech-to-text conversion may not be exact, the reordering of the search results helps remove poor results from the first 20 or 30 search results.

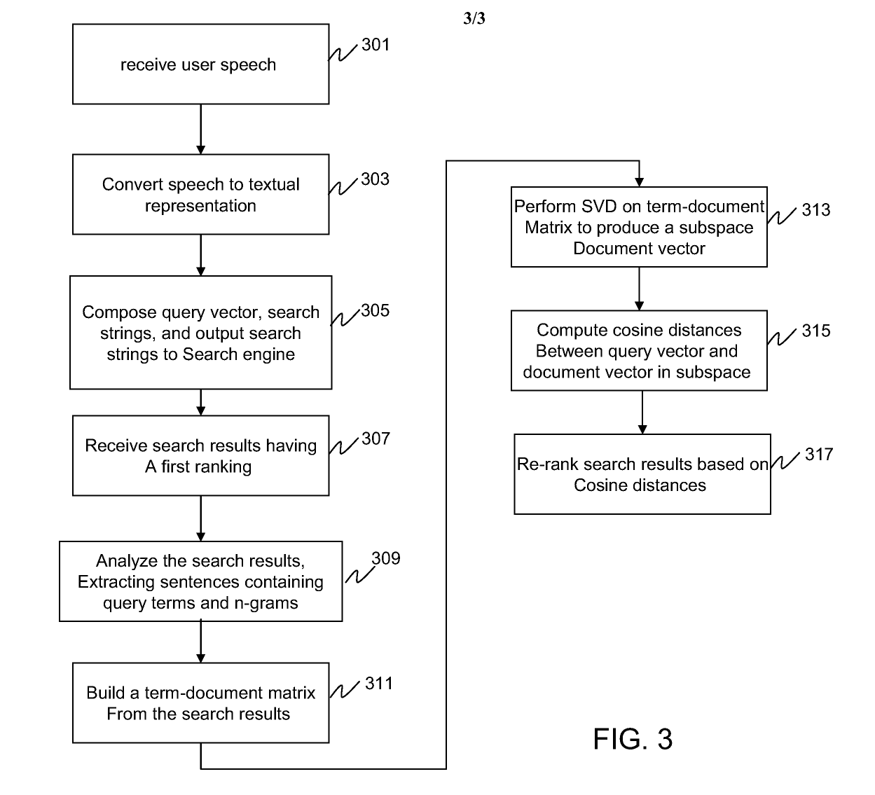

FIG. 3. is a flow chart showing operation of the system of FIG. 1. The logic flow begins at step 301 where speech recognition circuitry 101 receives speech as a spoken user query, creates a word lattice of the spoken query to (step 303), and outputs the word lattice to logic circuitry 102 as word lattice 200.

At step 305, logic circuitry 102 composes multiple search strings from word lattice 200 by extracting unigrams and bigrams from the word lattice. The search strings comprise N-grams, unigrams, and bigrams of the word lattice output of the speech-to-text conversion system. A query vector is created comprising the multiple search strings created from the word lattice. Once the query vector has been created, logic circuitry 102 derives search requests made from the search strings of the query vector and outputs the search requests to search engine 103. As discussed above, search engine 103 may be internal or external to apparatus 100, and may comprise a web-based search engine or an internal document search engine.

At step 307 logic circuitry 102 receives search results for each search request (e.g., 20 web pages for each search string of the query vector), with each search result having a first ranking, or ordering of the 20 web pages. As one of ordinary skill in the art would recognize, the search results are directly related to what was searched. For example, if internet web pages were searched, the search result would comprise ranked addresses for the web pages searched. As another example, if a file system was searched, the search result would comprise a list of rank-ordered files.

As discussed above, the search results will be re-arranged or reordered based on a semantic similarity between the search results and the word lattice. There may be several techniques to accomplish this task. For example, similarity metrics based on parsing, large corpus analysis, word sense databases, web search engine results, etc.

In the preferred embodiment of the present invention, a similarity of search results to the word lattice is accomplished by creating a table (term document matrix (A)) that contains sentences with the search strings (obtained from the word lattice) for each returned document. A singular value decomposition (SVD) is performed on the term-document matrix to produce a subspace document matrix (D) containing subspace document vectors. Mathematically D corresponds to A in that the columns of D represent “term weights” for each document within A. Confidence values (c1, c2, . . . , cN) of the N search strings within the query vector are obtained as vector q, and the cosine distances are computed between the query vector and the subspace document vectors (i.e., columns from matrix A′). The search results are then reordered based upon this distance. Steps 309 through 317 explain this process.

At step 309 the search results are analyzed and sentences within the web pages or documents that contain the query terms and n-grams from the query vector are extracted and stored in a table in storage 104. For example, if one search string was “all by myself”, and a returned web-page #1 had the sentence extracted “All the food was made by myself”, then an entry for web-page #1 in the table would contain the words “all the food was made by myself”. Multiple sentences may be stored for each web page.

Once all of the returned search results are analyzed for the query terms, and sentences stored for each document returned in the search, a term-document matrix is created from the search results (step 311). The term-document matrix comprises documents identifications for rows, and words found in the stored sentences as columns (or vice versa). The field of the matrix comprises the number of occurrences for each word/document combination. A simplified table is given below for illustration.

| Word/Document | Document #1 | Document #2 | Document #3 |
|---|---|---|---|
| all | 1 | 0 | 2 |
| by | 1 | 1 | 1 |
| myself | 1 | 2 | 3 |
| by myself | 1 | 0 | 2 |
| food | 1 | 0 | 0 |
| automobile | 0 | 1 | 3 |
| . | . | . | . |
| . | . | . | . |
| . | . | . | . |

From the above table, the term-document matrix would be:

$$A = \{ \begin{matrix}1 , 0 , 2 … \\ 1 , 1 , 1 … \\ 1 , 2 , 3 … \\ 1 , 0 , 2 … \\ 1 , 0 , 0 … \\ 0 , 1 , 3 … \\ … \\ … \\ …\end{matrix} \} .$$

Continuing, at step 313, singular value decomposition (SVD) is performed on the term-document matrix to produce subspace document vectors. In the preferred embodiment of the present invention SVD is performed as described in “Indexing by Latent Semantic Analysis” by Deerwester et al., Journal of the American Society for Information Science, 1990, Vol. 41, pp. 391-407, and incorporated by reference herein.

By performing the SVD, matrix A can be rewritten as:

A=TSD^{T}

Where T consists of term vectors, D consists of subspace document vectors and S is a diagonal matrix. Mathematically D corresponds to A in that the columns of D represent “term weights” for each search document returned. Matrix A will be modified by setting the singular values below a certain threshold to zero and removing them from the matrix S. A subspace spanned by the k term vectors in Tₖ is then obtained, where k is the number of singular value above a certain threshold value. Matrix A is transformed into a semantic space A′ as:

A′=TₖSₖ′Dₖ^{T}

Each subspace document vector can be represented in the space spanned by term vector as:

d′ᵢ=dᵢTₖSₖ′⁻¹

Similarly, a vector q can be obtained which represents confidence values of search strings within the query vector such that:

$$q = ( \begin{matrix}confidence \text{-} value \\ c 1 \\ c 2 \\ c 3 \\ c 12 \\ c 13\end{matrix} ) .$$

To compare with subspace document vector, the vector q can be transformed into q′ as:

q′=qTₖSₖ⁻¹

Similarity computation or called cosine distance between vector q′ and a subspace document vector d′ is calculated as follows:

$$sim ( q , {d}_{i} ) = \frac{{q}^{′} \cdot {d}_{i}^{′}}{\vert {q}^{′} \vert \vert {d}_{i}^{′} \vert} .$$

At step 315 the cosine distances are computed between the query vector and the document vectors (i.e., columns from matrix A′) in subspace. This results in a set of distance values between the query vector and each document within the term-document matrix.

Finally at step 317 the search results are re-ranked based on the cosine distance values from largest to smallest. (Cosine distances are ranked from +1 to −1, with higher cosine distances representing a better match between two vectors). More particularly, if 20 queries were generated resulting in 400 web pages (20 for each query), each query would have a “distance” from the subspace document vector. The 400 web pages are then reordered by choosing the web pages returned from query vectors having a least distance, and ordering them based on their confidence values.

While the invention has been particularly shown and described with reference to a particular embodiment, it will be understood by those skilled in the art that various changes in form and details may be made therein without departing from the spirit and scope of the invention. It is intended that such changes come within the scope of the following claims:

1. A method for reordering search results obtained from a search engine, the method comprising the steps of:
receiving speech;
creating a word lattice from the received speech;
creating a query vector comprising search strings from the word lattice;
sending the search strings to a search engine;
receiving search results from the search engine;
reordering the search results based on a semantic similarity between the search results and the word lattice.

2. The method of claim 1 wherein the step of receiving speech comprises the step of receiving a spoken query.

3. The method of claim 1 wherein the word lattice comprises a weighted graph of word hypotheses derived from the spoken input.

4. The method of claim 1 wherein the search strings comprise N-grams, unigrams, and bigrams of the word lattice output of the speech-to-text conversion system.

5. The method of claim 1 wherein the search engine comprises a web-based search engine.

6. The method of claim 1 wherein the search engine comprises a search engine that searches locally-stored files.

7. The method of claim 1 wherein the step of reordering the search results comprises the steps of:
creating a term-document matrix (A) that contains sentences with the search strings, obtained from the word lattice, for each returned document;
performing a single-value decomposition on the term-document matrix to produce a subspace document matrix (D) containing subspace document vectors, wherein D corresponds to A in that the columns of D represent “term weights” for each document within A;
obtaining confidence values q=(c1, c2, . . . , cN) of N search strings within the query vector;
finding a distances between q and the subspace document vectors; and
reordering the search results based on the distances between q and the subspace document vectors.

8. A method for reordering search results obtained from a search engine, the method comprising the steps of:
creating a query vector comprising search strings from a word lattice created from spoken words;
sending the search strings to a search engine;
receiving search results from the search engine;
reordering the search results based on a semantic similarity between the search results and the word lattice.

9. The method of claim 8 further comprising the step of receiving speech.

10. The method of claim 8 wherein the word lattice comprises a weighted graph of word hypotheses derived from the spoken input.

11. The method of claim 8 wherein the search strings comprise N-grams, unigrams, and bigrams of the word lattice output of the speech-to-text conversion system.

12. The method of claim 8 wherein the search engine comprises a web-based search engine.

13. The method of claim 8 wherein the search engine comprises a search engine that searches locally-stored files.

14. The method of claim 8 wherein the step of reordering the search results comprises the steps of:
creating a term-document matrix (A) that contains sentences with the search strings, obtained from the word lattice, for each returned document;
performing a single-value decomposition on the term-document matrix to produce a subspace document matrix (D) containing subspace document vectors, wherein D corresponds to A in that the columns of D represent “term weights” for each document within A;
obtaining confidence values q=(c1, c2, . . . , cN) of N search strings within the query vector;
finding a distances between q and the subspace document vectors; and
reordering the search results based on the distances between q and the subspace document vectors.

15. An apparatus for reordering search results, the apparatus comprising:
logic circuitry creating a query vector comprising search strings from a word lattice, the logic circuitry sending the search strings to a search engine, receiving search results from the search engine, and reordering the search results based on a semantic similarity between the search results and the word lattice.

16. The apparatus of claim 15 wherein the word lattice comprises a weighted graph of word hypotheses derived from the spoken input.

17. The apparatus of claim 15 wherein the search strings comprise N-grams, unigrams, and bigrams of the word lattice output of the speech-to-text conversion system.

18. The apparatus of claim 15 wherein the search engine comprises a web-based search engine.

19. The apparatus of claim 15 wherein the search engine comprises a search engine that searches locally-stored files.

20. The apparatus of claim 15 wherein the step of reordering the search results comprises the steps of:
creating a term-document matrix (A) that contains sentences with the search strings, obtained from the word lattice, for each returned document;
performing a single-value decomposition on the term-document matrix to produce a subspace document matrix (D) containing subspace document vectors, wherein D corresponds to A in that the columns of D represent “term weights” for each document within A;
obtaining confidence values q=(c1, c2, . . . , cN) of N search strings within the query vector;
finding a distances between q and the subspace document vectors; and
reordering the search results based on the distances between q and the subspace document vectors.
